(19) United States
(12) Patent Application Publication
(10) Pub. No.: US 2022/0379244 A1
(43) Pub. Date: Dec. 1, 2022

(54) SYSTEM FOR SIGNALING AND/OR DISPLAYING A DEPLETION CONDITION OF A FILTER CARTRIDGE

(71) Applicant: LAICA S.P.A., Barbarano Mossano (VI) (IT)

(72) Inventor: Maurizio MORETTO, Vicenza (IT)

(73) Assignee: LAICA S.P.A., Barbarano Mossano (VI) (IT)

(21) Appl. No.: 17/770,492

(22) PCT Filed: Oct. 21, 2020
(86) PCT No.: PCT/IB2020/059893

§ 371 Date: Apr. 20, 2022

(30) Foreign Application Priority Data
Oct. 22, 2019 (IT) 102019000019535

(51) Int. Cl. B01D 27/10; C02F 1/28; C02F 1/42; C02F 1/00

(52) U.S. Cl. CPC B01D 27/101; C02F 1/283; C02F 1/42; C02F 1/003; C02F 2201/006; C02F 2209/445; C02F 2209/008; C02F 2209/055; C02F 2209/29; B01D 2201/56; C02F 2307/04; C02F 2307/06

(57) ABSTRACT

A system for signaling and/or displaying a depletion condition of a filter cartridge in a water treatment device by means of filtration with replaceable cartridges. The filter cartridge including an identification code which identifies the cartridge and which can be read by means of an optical reader of a portable electronic device. The portable electronic device includes a programmable control interface which can be displayed on a screen of the portable electronic device, by means of which it is possible to acquire identification data of the cartridge, to modify one or more predefined or previously imposed parameters in relation to the conditions of use of the cartridge, and to display the effective duration of the cartridge.

### CROSS-REFERENCE TO RELATED APPLICATIONS

The present application is a § 371 U.S. National Phase of PCT/IB2020/059893, filed Oct. 21, 2020, which claims priority to Italian Patent Application Number 102019000019535, filed Oct. 22, 2019, the entire contents of all of which are incorporated by reference herein as if fully set forth.

### FIELD OF THE INVENTION

The invention relates to a system for signaling and/or displaying a depletion condition of a replaceable filter cartridge which can be carried out by means of a portable electronic device, for example, a Smartphone.

### BACKGROUND

In the context of water treatment systems, there is widely provision for the use of replaceable filter cartridges.

Such cartridges typically contain a filter material, the filtration capacities of which gradually become depleted over time.

The need to replace the cartridge may be shown by a metering device which detects the number of filtering cycles carried out or the number of liters processed or the time passed from the time of the first activation of the cartridge. Examples of these solutions are described in the international patent application WO 2009/090678.

Another example is set out by the international patent application WO 2009/015680 which allows the user to manually carry out a correction of a parameter which represents the residual time of use and/or the level of depletion of the cartridge in accordance with chemical/physical parameters of the water to be filtered.

Other examples of systems for establishing the useful life of a filter cartridge are described in CN107911439 or CN105214374. In these cases, there is used a cloud system for updating in real time the expected useful life of the cartridge on the basis of the effective conditions of use.

However, there is perceived the need to allow a greater personalization of the parameters on the basis of which the calculations of the residual time of use are carried out and to increase the simplicity of use with respect to known systems.

At the same time, there is required a solution to this problem which has no influence, or in any case a minimal influence, on the production costs both of the filter device and of the cartridge.

The technical problem addressed by the present invention is therefore to provide a system for signaling and displaying a depletion condition of a replaceable filter cartridge which is structurally and functionally configured to overcome all the disadvantages set out with reference to the cited prior art.

### SUMMARY

This problem is solved by means of a system for signaling and displaying a depletion condition of a replaceable filter cartridge and the method for carrying out the system, comprising one or more of the features set out in the appended claims.

It will be appreciated that the system according to the present invention allows use to be made of portable electronic devices, such as, for example, a Smartphone, for controlling the replacement of the cartridge. This possibility requires only the presence on the cartridge of an identification code which can be read by means of an optical device of the electronic device, such as, for example, the camera of the Smartphone.

Consequently, the implementation of the system does not have any influence, or eventually it has only a minimal influence, on the production costs of the cartridge and the filter device.

The use of a Smartphone or another electronic device further allows simple programming of the interface by means of which the user can personalize the parameters, on the basis of which the provision of the remaining useful life of the cartridge is carried out.

According to another aspect of the invention, the water treatment device comprises a transparent main body. The identification code is positioned on the cartridge so as to be visible from the exterior of the water treatment device through the transparent main body.

In this manner, the Smartphone or other electronic device may also be used for reading the identification code when the cartridge is received in the water treatment device.

### BRIEF DESCRIPTION OF THE DRAWINGS

The features and additional advantages of the invention will be better appreciated from the following detailed description of a preferred though non-limiting embodiment thereof which is illustrated by way of non-limiting example with reference to the appended drawings, in which:

FIG. 1 is a schematic illustration of the system according to the present invention; and

FIG. 2 is a perspective view of a filter cartridge which can be used in an alternative embodiment of the system according to the present invention.

### DETAILED DESCRIPTION OF THE PREFERRED EMBODIMENTS

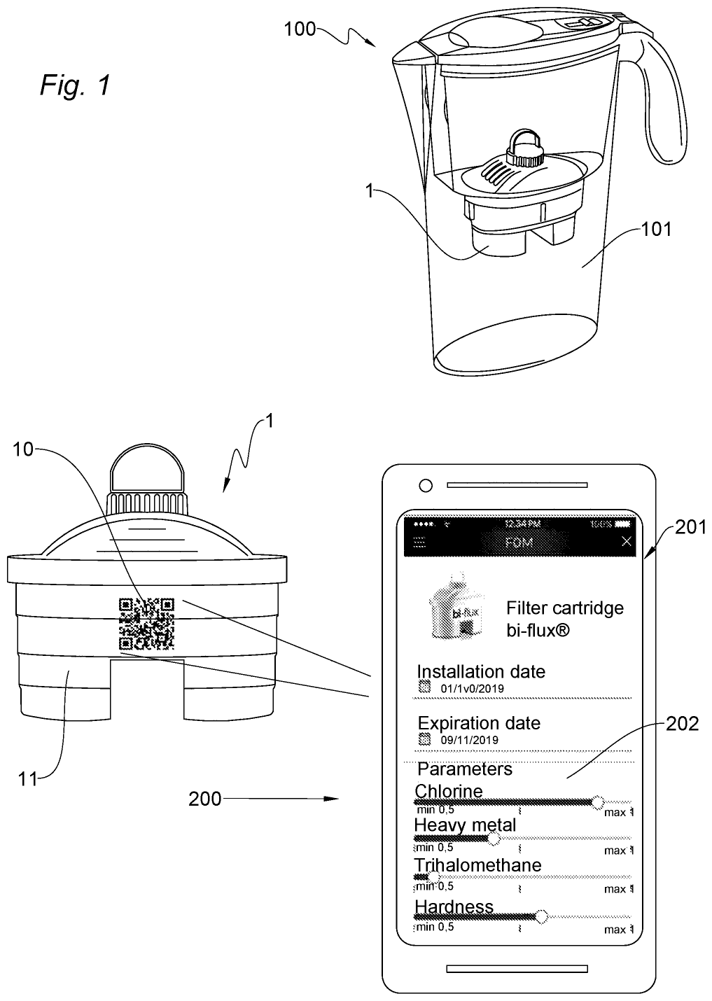

With reference to FIG. 1, there is generally designated 100 a water treatment device by means of filtration according to the present invention.

In a preferred embodiment, the water treatment device 100 is of the percolation type and comprises a main body 101 which is preferably of jug-like form and in which there is defined a seat, inside which a filter cartridge 1 can be received in a removable manner.

There are preferably defined in the main body 101 an upper reservoir for collecting the water to be filtered and a lower reservoir in which the filtered water is collected once it has passed through the filter cartridge. In some embodiments, there may be provision for a funnel-like divider element (hopper) which defines the above-mentioned upper reservoir, on the base of which the seat for the cartridge 1 is formed.

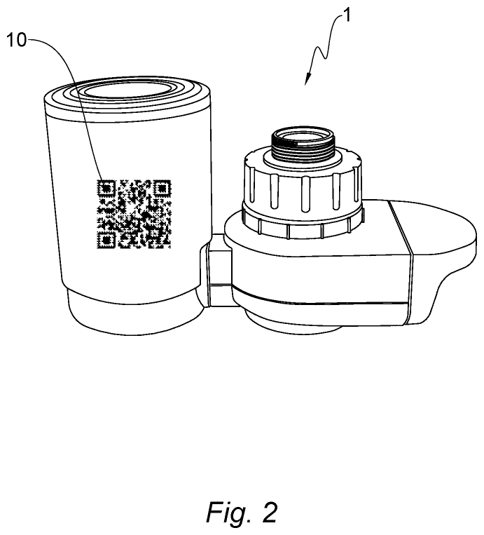

It will be appreciated that the system 100 of the present invention may also be used with treatment devices of different types. For example, FIG. 2 illustrates a filter cartridge of a different type which can be used in a tap. On the basis of yet another example, the filter cartridge may also be formed by a carbon fiber filter element which can be inserted in a suitable housing which is constructed in the same treatment device.

Generally, in the system of the present invention the filter cartridge 1 comprises an identification code 10 which is preferably positioned on an external surface thereof. In any case, it will be appreciated that the identification code 10 may also not be arranged directly on the cartridge 1 but instead may be positioned on the packaging thereof, on the cover of the filter device 101 on which the cartridge 1 is used, on a removable extension piece of the cartridge, on a removable label which is attached to the cartridge. These alternative solutions may be advantageous if the dimensions of the cartridge could make it difficult to imprint or bond the code 10 or if the cartridge is formed directly by the filter element, as in the example of the carbon fiber filter described above.

The identification code 10 is particularly intended to allow identification of the cartridge, for example, in terms of type. For example, the water treatment device 100 could be intended for the use of cartridges of various types which differ as a result of the characteristics of the filter material contained therein. In any case, it is evident that the identification code 10 may also allow the identification of the cartridge on the basis of other characteristics, such as, for example, the manufacturer, a production batch, a use-by date. Furthermore, the same system may be used for the control of a plurality of cartridges of different types, such as, for example, the one illustrated in FIG. 2, and therefore the code 10 may also be used for the simultaneous control of a plurality of cartridges.

In preferred embodiments, the identification code 10 is a QR code or a bar code.

These types of code are particularly advantageous because they allow simple reading by means of optical readers in common use.

In fact, it will be appreciated that, on the basis of another aspect of the invention, the identification code 10 which identifies the cartridge can be read by means of an optical reader of a portable electronic device 200.

Preferably, the portable electronic device 200 is a Smartphone and the optical reader for reading the code is constituted by the camera with which Smartphones are typically provided.

The identification code 10 may advantageously be printed on the body of the cartridge 1 or applied thereto. The printing operation may also be carried out, for example, by laser etching on an external packaging of the cartridge 1. To this end, in some embodiments, the cartridge 1 comprises an external casing 11, for example, of plastics material, inside which there is present filter material, preferably in granular form, such as, for example, ion-exchange resin or activated carbon.

In preferred embodiments, the main body 101 is transparent and the identification code 10 is positioned on the cartridge 1 so as to be visible from the exterior of the water treatment device 100 through the transparent main body 101.

The reading of the identification code 10 therefore allows the electronic device 200 to acquire identification data of the cartridge 1 as a function of the identification code 10 itself.

The electronic device 200 is configured to process the identification data of the cartridge 1 so as to provide the user with an indication that a depletion condition of the cartridge has been reached.

To this end, the electronic device 200 may comprise a programmable processing unit, by means of which the method for establishing the depletion condition of the present invention can be carried out.

For example, in the case of a Smartphone, there may be provided an app, by means of which the method which will be illustrated in detail below according to a preferred embodiment is carried out.

As mentioned above, the reading of the code 10 allows the cartridge to be identified and, by means of the app, an expected duration of the cartridge to be established.

This duration will represent a time period expected for the depletion condition of the cartridge 1 to be reached, on the basis of a series of predefined or predetermined parameters. The establishment of the expected duration may be carried out by means of a database, which is or can be stored in the device 200 and which allows an expected duration to be associated with the type of cartridge.

It will be appreciated that the duration of the cartridge, which is intended to be understood to be the time range within which the filter capacity thereof does not decrease below a predetermined threshold, is variable in accordance with various parameters, which typically represent both the type of water to be treated and the methods of use of the filter device.

In other words, once the type of filter has been identified, the app is configured so as to provide a default duration of the cartridge, for example, in the form of an expiry date, on the basis of predefined or previously imposed parameters.

As mentioned above, the predefined or previously imposed parameters which affect the effective duration of the cartridge may not correspond to the ones in real use.

Consequently, the app allows the modification by a user of one or more of the predefined or previously imposed parameters.

To this end, there may be provision for the use of an interface 202 which allows modification, for example, by means of scroll bars or selection push-buttons, of different parameters and which influence the duration of the cartridge.

Advantageously, the characteristic parameters of the water which can be modified by the user comprise one or more of: hardness of the water, quantity of chlorine, quantity of heavy metals, quantity of trihalomethanes.

According to another aspect, the parameters which represent the operating conditions of the cartridge which can be modified by the user comprise one or more of: expected quantity of liquid filtered per day, total number of users of the water treatment device 100, typically corresponding to the number of persons which form the household, frequency of use, for example, daily, of the water treatment device 100.

Naturally, the above-mentioned lists have to be considered to be exemplary and non-limiting with respect to the parameters which may be subject to modification in the system according to the present invention.

Therefore, it will be appreciated that the use of a Smartphone and a relevant app may allow the desired parameters to be readily imposed on the basis of the water. For example, in the presence of high quantities of chlorine in the water supplied by the public water network, a high value will be input in the user interface.

At this point, there may be determined an effective duration of the cartridge 1 on the basis of the modified parameters.

In other words, the app can read the parameters imposed by the user and recalculate the duration of the cartridge.

The weighting of the modification of the parameters can be formed experimentally, for example, by reducing the duration with respect to the one expected, by a predefined percentage for each modification of the parameters. Naturally, alternatively or additionally, there may be provided specific correction algorithms.

In this manner, the effective duration may represent the effective time period expected for reaching the depletion condition of the cartridge 1 on the basis of the parameters as modified.

Therefore, this information may be transmitted to the user using different methods. For example, a notification may be conveyed to the user, by means of email or other notification system, when the depletion condition of the cartridge is reached. Additionally, or alternatively, there may be displayed the effective duration of the cartridge 1 and/or a depletion date of the cartridge 1 calculated on the basis of the parameters as modified.

It is evident that the use of a Smartphone readily allows the above-mentioned functionalities to be implemented.

In any case, the method of the present invention can also be carried out with different electronic devices which comprise at least one programmable control interface 202 and a respective screen 201, on which it may be displayed.

The invention thereby solves the problem set out, at the same time achieving a plurality of advantages. The system may in fact notify the user of the need to replace the cartridge without any need for providing the filter systems with complex and relatively expensive counting devices. In this manner, it is also possible to use the cartridges in the correct manner, taking into account the parameters of effective use.

It is understood, therefore, that this invention is not limited to the particular embodiments disclosed, but is intended to cover all modifications which are within the spirit and scope of the invention as defined by the appended claims; the above description; and/or shown in the attached drawings.

1. A system for signaling and/or displaying a depletion condition of a filter cartridge (1) in a water treatment filtration device (100), which utilizes replaceable cartridges, wherein the filter cartridge (1) comprises an identification code (10), which identifies the cartridge and which can be read by an optical reader of a portable electronic device (200), the system comprising a programmable control interface (202), which can be displayed on a screen (201) of the portable electronic device (200), the programmable control interface (202) being configured to:
acquire identification data of the cartridge (1) as a function of the identification code (10);
establish an expected duration of the cartridge which represents an expected time period for reaching the depletion condition of the cartridge (1) on the basis of predefined or previously imposed parameters;
allow modification by a user of one or more of the predefined or previously imposed parameters;
establish an effective duration of the cartridge (1) on the basis of the modified parameters, the effective duration being representative of the effective time period expected for reaching the depletion condition of the cartridge (1) on the basis of the parameters as modified;
display the effective duration of the cartridge (1) and/or a depletion date of the cartridge (1) calculated on the basis of the parameters as modified and/or notify the user of the depletion condition of the cartridge being reached.

2. The system according to claim 1, wherein the portable electronic device (200) is a Smartphone.

3. The system according to claim 1, wherein the identification code (10) is a QR code or a bar code.

4. The system according to claim 1, wherein the predefined or previously imposed and modifiable parameters comprise parameters which are characteristic of the water to be treated.

5. The system according to claim 4, wherein the parameters which are characteristic of the water to be treated comprise at least one of the following:
hardness of the water;
quantity of chlorine;
quantity of heavy metals;
quantity of trihalomethanes.

6. The system according to claim 1, wherein the predefined or previously imposed and modifiable parameters comprise parameters which are representative of operating conditions of the cartridge by the user.

7. The system according to claim 6, wherein the parameters which are representative of operating conditions of the cartridge by the user comprise at least one of the following:
expected quantity of liquid filtered per day;
total number of users;
frequency of use of the water treatment device (100).

8. The system according to claim 1, wherein the water treatment device (100) is of the a percolation type.

9. The system according to claim 1, wherein the identification code (10) being positioned on the cartridge (1).

10. The system according to claim 9, wherein the water treatment device (100) comprises a transparent main body (101) which is capable of receiving the cartridge (1) in a removable manner, the identification code (10) being positioned so as to be visible from the exterior of the water treatment device (100) through the transparent main body (101).

11. A method for establishing and displaying a depletion condition by means of the system according to claim 1, the method comprising:
acquiring identification data of the cartridge (1) as a function of the identification code (10);
establishing an expected duration of the cartridge which represents an expected time period for reaching the depletion condition of the cartridge (1) on the basis of predefined or previously imposed parameters;
modifying one or more of the predefined or previously imposed parameters;
establishing an effective duration of the cartridge (1) on the basis of the modified parameters, the effective duration being representative of the effective time period expected for reaching the depletion condition of the cartridge (1) on the basis of the parameters as modified;
displaying the effective duration of the cartridge (1) and/or a depletion date of the cartridge (1) calculated on the basis of the parameters as modified and/or notifying the user of the depletion condition of the cartridge being reached.
